(19) United States
(12) Patent Application Publication
(10) Pub. No.: US 2023/0095796 A1
(43) Pub. Date: Mar. 30, 2023

(54) METHOD FOR PIPELINED FORMATION OF A BLOCKCHAIN GUARANTEEING TRANSACTION LIVENESS

(71) Applicant: COMMISSARIAT A L'ENERGIE ATOMIQUE ET AUX ENERGIES ALTERNATIVES, Paris (FR)

(72) Inventors: Antonella DEL POZZO, Gif-Sur-Yvette Cedex (FR); Sara TUCCI, Gif-Sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 17/946,372

(22) Filed: Sep. 16, 2022

(30) Foreign Application Priority Data
Sep. 17, 2021 (FR) 21 09794

(51) Int. Cl. H04L 9/32; H04L 9/00

(52) U.S. Cl. CPC H04L 9/3263; H04L 9/50

(57) ABSTRACT

A method for forming a blockchain allowing to ensure that any transaction emitted by a client is incorporated into the blockchain. This method involves N validator nodes of the network, including at most F faulty nodes with N > 3F , and implements a consensus mechanism tolerant of Byzantine faults. Each validator node forms a block of transactions received from the clients by selecting them according to their order of arrival and broadcasts this block to the other validator nodes. The validator node concatenates the block that it formed with a plurality of blocks received from the other nodes to form a composite block of f ≥ F + 1 blocks. Each validator node determines whether the composite blocks that it receives from the other validator nodes are valid, and if it receives N - F approval messages for the same composite block, validates the latter in the form of a decided composite block by adding to it a quorum certificate.

### DESCRIPTION

### Technical Field

The present invention relates to the general field of blockchains and more particularly those operating on a consensus tolerant of Byzantine faults, also called BFT (Byzantine Fault Tolerance).

### Prior Art

The term blockchain designates both a peer-to-peer network without a central authority, managing a distributed ledger, and a data structure consisting of consecutive blocks chained to each other, each block comprising transactions emitted by clients (nodes of the network). Here, the term blockchain will be considered according to the second meaning and the acronym BC will be used to designate the first.

Some BCs (in particular Ethereum) allow to execute decentralised applications (DAPP) or smart contracts. The clients wishing to access such an application interact with it by transmitting transactions to it.

Other BCs (for example Bitcoin) only authorise rather limited transactions, typically a transfer of an amount of cryptocurrency between an emitter UTXO (Unspent Transaction Output) and a receiver UTXO.

Regardless of the type of BC, the transactions are concatenated in blocks, themselves stored in the blockchain after they have been validated by a mechanism for consensus among validator nodes. In certain BCs, any node can theoretically be a validator node (public BCs), in others this function can only be exercised after authorisation (commissioned BCs) or at dedicated nodes (private BCs).

Each of the validator nodes receives in an asynchronous manner, generally according to a mechanism for point-to-point propagation in the network, the transactions emitted by the clients. After having verified the transactions received, each validator node concatenates them and forms a block that it proposes to its peers to integrate it into the chain.

A large number of validation mechanisms are known from the art (PoW, PoS, etc.), the most well-known being that based on proof of work (PoW), used for example in the blockchains Bitcoin and Ethereum. However, this validation mechanism, based on the resolution of a cryptographic problem, consumes a lot of energy and does not prevent the appearance of forks, that is to say situations of divergence in which validator nodes integrate blocks into the chain concurrently.

The most promising validation mechanisms are currently those based on consensus mechanisms of the BFT (Byzantine Fault Tolerant) type. A detailed description of this type of consensus can be found in the article by M. Castro and B. Liskov entitled “Practical Byzantine fault tolerance and proactive recovery” published in ACM Transactions on Computer Systems, Vol. 20, No. 4, November 2002, pp. 398-460.

A consensus mechanism of the BFT type ensures that if, among the N validator nodes at most one third (F < N /3) are faulty (or Byzantine according to the agreed terminology), the blocks of transactions coming from the consensus are indeed valid and thus composed of transactions themselves valid.

A consensus mechanism of the BFT type is shown schematically in FIG. 1, with N = 4 validator nodes, each executing a validation process.

The validation processes Pₙ ,n = 1,..,N provide validation results, for example results of cryptographic primitives on the block to be validated.

It has been supposed here that the node 1 is Byzantine and that consequently the process P₁ could provide false values. However, in theory, two non-faulty validator nodes never decide differently.

The validator nodes determine the next block to be added to the blockchain. For the same position in the blockchain, the validator nodes make a decision on the same block. In the case illustrated, the nodes respectively calculate the relative validation results on the blocks

$${b}_{1} {}^{′} , {b}_{1} {{}^{′}}^{′} , {b}_{1} {{}^{′}}^{′} {}^{′} , {b}_{1} {{}^{′}}^{′} {{}^{′}}^{′}$$

and decide to choose the block b;″ on the basis of a consensus mechanism.

The details of the consensus mechanism are illustrated in FIG. 2, it generally comprises a plurality of successive iterations, each iteration comprising a proposition step (propose), a consultation step (prevote) including calculations as well as exchanges of message and, finally, an approval step (endorse). The proposition step is carried out by the various nodes in turns, round-robin. During the approval step, each validator node indicates to the other nodes, via an approval message, whether it approves the validation results provided by the other nodes.

When at least N-F validator nodes approve the same validation result during the same iteration, the corresponding block is considered to be valid and a quorum certificate is generated.

More precisely, a block bᵢ (where i is the rank of the block in the chain) comprises a pointer to the preceding block bᵢ₋₁ (for example the hash of this block), the quorum certificate of the preceding block, QCᵢ₋₁, and all of the transactions concatenated in the block.

During each instance of consensus, the messages exchanged among the validator nodes comprise the rank of the block in the chain, the number of the iteration, the reference of the step in the iteration, the validation result obtained by the validator node, all of this being signed by the validator node emitting the message. The messages transmitting the validation results are called validation messages.

When a validator node approves a validation result for a block, it transmits an approval message (endorse) to the other nodes.

Finally, the quorum certificate, QCᵢ, relative to a block bᵢ comprises, for each validator node having approved the consensus value, the rank of the block in the chain, said consensus value and the index of the iteration during which this value was approved. The quorum certificate contains the at least N-F approval messages of the validator nodes that approved the consensus value.

For a validator node, the output of the consensus mechanism is composed, on the one hand, of a block, the validation results of which were approved by at least N-F validator nodes and, on the other hand, of the corresponding quorum certificate. When the block is associated with a quorum certificate, it is designated as a “decided” block, that is to say, a block validated by consensus. Thus, in the case illustrated,

$$D e c i d e \left({b}_{1} {{}^{′}}^{′} {}^{′}\right) = \left({b}_{1} {{}^{′}}^{′} {}^{′} , Q {C}_{1} {{}^{′}}^{′} {}^{′}\right)$$

and

$${b}_{1} {{}^{′}}^{′} {}^{′}$$

is the decided block provided by the third validator node.

FIG. 3 shows the steps carried out by a validator node participating in the consensus mechanism of the BFT type.

Each validator node receives the transactions emitted by the clients (propagation step by step in the network according to a broadcasting of the Best Effort type) and has available its own copy of the blockchain, stored locally. The transactions incorporated into the blockchain can then be executed by an application layer above the blockchain for example by a DAPP (decentralised application).

Each validator node further has available a memory in which the transactions that it receives are stored.

The management of the transactions by the validator node is carried out via an iterative loop.

When the validator node observes in 310 that a new block is validated by consensus, in other words that a new block having the rank i with its quorum certificate, QCᵢ, is available, it adds this new block to its local copy of the blockchain. A validator node only adds a new block to its local copy of the blockchain insofar as the pointer of this new block points to the last block of the copy in question.

As soon as a new block is incorporated into the blockchain, more precisely into its local copy, the validator node deletes from the queue all the transactions present in this new block, 320.

The validator node then prepares in 330 a candidate block by selecting the first transactions available in the queue, that is to say by popping the buffer FIFO, and proposes the block thus formed to all of the other validator nodes after having incorporated into it the quorum certificate of the preceding block, QCᵢ₋₁ .

In 340, the candidate block thus obtained is submitted to the mechanism of consensus among validator nodes shown in FIG. 2. The process of management of the transactions by the validator node then continues by returning to step 310.

While the consensus mechanisms of the BFT type allow to ensure that the blocks of transactions integrated into the blockchain are indeed composed of valid transactions, they do not guarantee that a valid transaction will eventually be incorporated into the blockchain. Indeed, a dishonest validator node can systematically censure a transaction and not integrate it into the blocks that it proposes, so as to indefinitely delay its incorporation into the chain.

The property according to which a transaction transmitted by a client will indeed be incorporated in the end into the blockchain, that is to say within a time period respecting a latency constraint (limited time period), is called transaction liveness. If the transactions of a client are systematically censured, in other words if its transactions are never incorporated into the blockchain, it is said that the blockchain lacks user fairness.

A method for forming a blockchain ensuring transaction liveness and user fairness was described in the article by S. Bonomi et al. entitled “SoK: Achieving state machine replication in blockchains based on repeated consensus”, 28 May 2021, available on arXiv.org.

However, this method for forming a blockchain includes a significant latency insofar as each iteration requires a step of proposition, of consultation then of approval of a set of blocks.

The object of the present invention is therefore to propose a method for forming a blockchain guaranteeing transaction liveness and user fairness while having reduced latency and a high bitrate.

### DISCLOSURE OF THE INVENTION

The present invention is defined by a method for forming a blockchain involving a plurality N of validator nodes, including at most F faulty nodes with N >3F, each validator node having available a local copy of the blockchain and receiving the transactions emitted by clients, each validator node further storing these transactions according to their order of arrival in a queue and creating a block of transactions by popping the queue starting from the oldest transaction, said method being original in that each validator node:
during a consensus phase of the BFT type, determines whether composite blocks, formed by a number ƒ of blocks with ƒ ≥ F+1, proposed by the other validator nodes during the current instance of validation are valid and, if yes, sends back to these nodes an extended approval message, said extended approval message comprising the composite block validated during the current instance of validation as well as a new block of transactions intended to form a new composite block during the following instance of validation;
when it has available at least N-F messages of approval of the same composite block, creates a decided block comprising said composite block and an extended quorum certificate, the extended quorum certificate being composed of said at least N-F extended approval messages relative to this composite block;
when it has available a decided block, adds the composite block in question to the local copy of the blockchain;
forms said new composite block from the new blocks of transactions contained in the ƒ extended approval messages of the extended quorum certificate.

Advantageously, each validator node transmits the transactions received from the clients to the other validator nodes according to a service of the Best Effort type.

According to one exemplary embodiment, the number of validator nodes comprises exactly F faulty ones and ƒ ≤ N-F.

Preferably, after having formed the new composite block, the validator node adds to it the quorum certificate of the preceding composite block as well as a pointer to the preceding composite block.

When a composite block is incorporated into the blockchain, the validator node advantageously deletes from its queue all the transactions present in this composite block.

The consensus phase typically comprises a plurality of successive iterations, each iteration comprising a proposition step in which each validator node proposes a block of transactions, a step of consultation among the validator nodes, and an approval step in which each validator node indicates to the others the composite block that it validated via an extended approval message that it transmits to them.

Advantageously, an extended approval message emitted by a validator node comprises the composite block validated by this node, the index of the iteration and the step of the iteration during which it validated it, the new block of transactions intended to form a new composite block during the following instance of validation, said approval message being signed by a private key of the validator node.

### BRIEF DESCRIPTION OF THE DRAWINGS

Other features and advantages of the invention will appear upon reading a preferred embodiment of the invention, described in reference to the appended drawings in which:

FIG. 1, already described, schematically shows a consensus mechanism of the BFT type used to validate a block in a blockchain;

FIG. 2, already described, shows various iterations involved in the execution of the consensus mechanism of FIG. 1;

FIG. 3, already described, shows in the form of a flowchart the steps carried out by a validator node in a method for forming a blockchain using a known consensus mechanism of the BFT type;

FIG. 4 schematically shows a consensus mechanism of the BFT type used in a method for forming a blockchain, according to an embodiment useful to the understanding of the invention;

FIGS. 5A to 5C schematically show a phase of certification of composite blocks and a consensus phase of the BFT type relating to these composite blocks, implemented in the consensus mechanism of FIG. 4;

FIG. 6 shows in the form of a flowchart the various steps carried out by a validator node in a method for forming a blockchain using a consensus mechanism of FIG. 4;

FIG. 7 schematically shows a consensus mechanism of the BFT type used in a method for forming a blockchain according to an embodiment of the present invention;

FIG. 8 shows in the form of a flowchart the steps carried out by a validator node in a method for forming a blockchain using a consensus mechanism of the BFT type, according to the embodiment of FIG. 7.

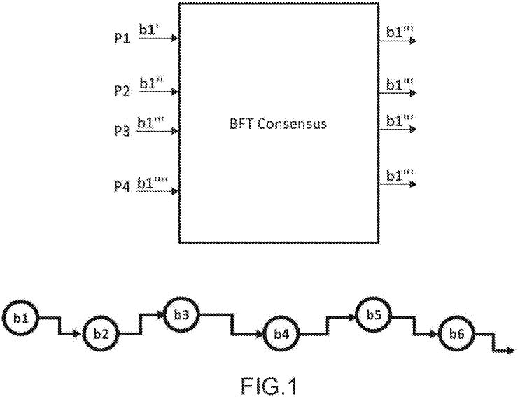

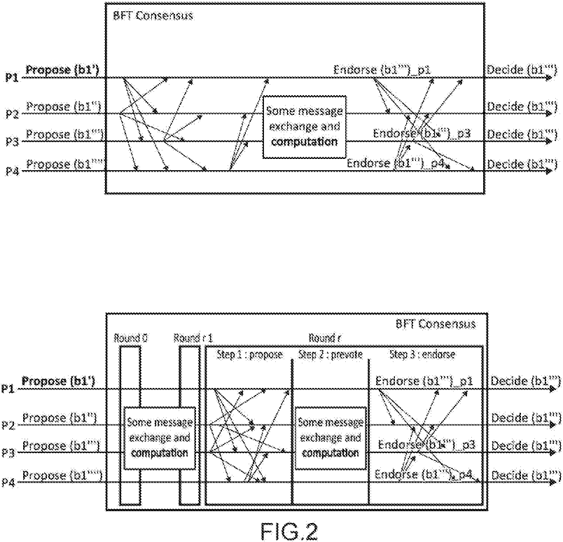

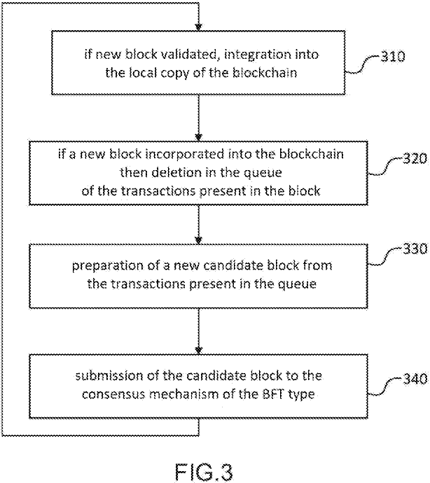

### DETAILED DISCLOSURE OF SPECIFIC EMBODIMENTS

Below, a method for forming blockchains using a mechanism for consensus of the BFT type among validator nodes, as disclosed in the introduction, will be considered. The method for forming a blockchain involves here again N validator nodes of the network, including at most F faulty nodes.

A first idea forming the basis of the present invention is to form composite blocks, each composite block resulting from the concatenation of ƒ candidate blocks, with ƒ ≥ F+1, out of the N candidate blocks proposed by the validator nodes and of the quorum certificate of the composite block. When the number of faulty nodes is exactly equal to F, the number f of candidate blocks concatenated in a composite block must satisfy the condition ƒ ≤ N-F. These composite blocks are then submitted to a consensus mechanism of the BFT type.

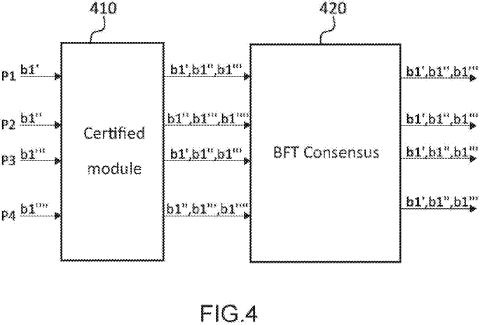

FIG. 4 schematically shows a consensus mechanism of the BFT type used in a method for forming a blockchain according to an embodiment useful to the comprehension of the present invention.

This consensus mechanism comprises a certification phase 410, aiming to generate certified composite blocks, followed by a consensus phase of the BFT type, 420.

As above, the case of N = 4 validator nodes was considered, each validator node executing a validation process, Pₙ ,n = 1,..,N . Only the node 1 is supposed to be Byzantine, in other words F = 1.

Each validator node forms a block by concatenating a predetermined number of successive transactions in the order of the queue, that is to say according to their order of arrival. It broadcasts the block thus obtained to all the other validator nodes via a service of the Best Effort type.

When a validator node has available ƒ ≥ F+1 blocks, here ƒ = N-F blocks, it constructs a composite block by concatenating the N-F blocks thus received.

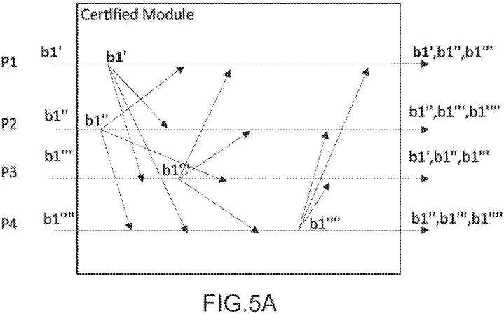

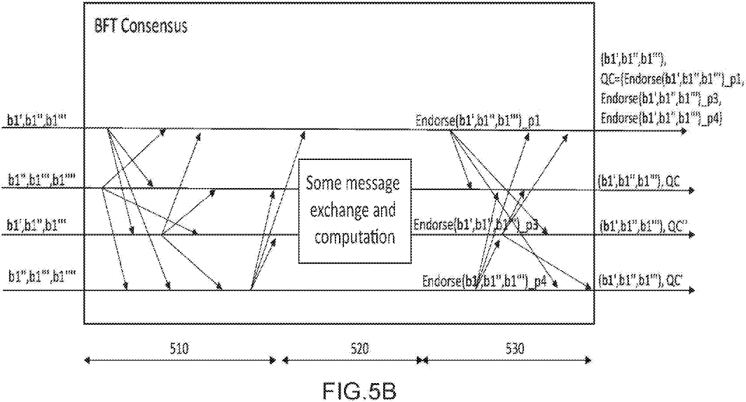

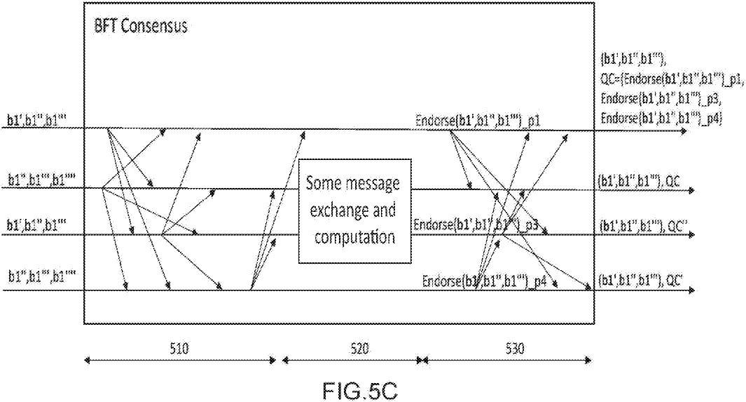

FIG. 5A illustrates the exchanges of blocks among validator nodes during the certification phase, as well as the formation of composite blocks by each of them. Thus, for example, the node 1 forms a composite block

$${b}_{1} {}^{′} , {b}_{1} {{}^{′}}^{′} , {b}_{1} {{}^{′}}^{′} {}^{′} ,$$

the node 2 forms a composite block

$${b}_{1} {{}^{′}}^{′} , {b}_{1} {{}^{′}}^{′} {}^{′} , {b}_{1} {{}^{′}}^{′} {{}^{′}}^{′} ,$$

etc.

Each of the composite blocks is then the object of a certification by adding to it on the one hand a pointer to the preceding certified composite block, B₀, stored in the blockchain and, on the other hand, the quorum certificate of the preceding composite block, QC₀.

The certified composite blocks are then submitted to a consensus mechanism of the BFT type in 420, also involving the N validator nodes. The consensus mechanism comprises a plurality of successive iterations, each iteration comprising a proposition step, a consultation step and an approval step, as described above.

Each validator node having formed a composite block from at least F + 1 blocks stored in its queue proposes it to the other validator nodes, which validate it or not. When a validator node validates a composite block, it diffuses a validation message to all of the nodes and signs it digitally (for example via its private key).

The operation of the consensus mechanism was illustrated in FIG. 5B.

Only the last iteration of the consensus phase is shown here for reasons of simplification. After the steps of proposition, 510, and of consultation, 520, the approval step 530 leads to a consensus among the N-F =3 validator nodes 1, 3 and 4 on the composite block

$${{b}^{′}}_{1} , {{b}^{″}}_{1} , {{b}^{‴}}_{1} .$$

Thus, in the example illustrated, the first validator node, after having broadcast the composite block b'₁,b₁″,b₁‴ , receives, after the consultation step, an approval message signed by the third node, Endorse

$$\left({{b}^{′}}_{1} , {{b}^{″}}_{1} , {{b}^{‴}}_{1}\right) \_ {p}_{3} ,$$

as well as an approval message signed by the fourth node

$$\left({{b}^{′}}_{1} , {{b}^{″}}_{1} , {{b}^{‴}}_{1}\right) \_ {p}_{4} .$$

Similarly, the third validator node, after having transmitted to the other validator nodes the composite block

$${{b}^{′}}_{1} , {{b}^{″}}_{1} , {{b}^{‴}}_{1} ,$$

receives an approval message signed by the first node,

$$E n d o r s e \left({{b}^{′}}_{1} , {{b}^{″}}_{1} , {{b}^{‴}}_{1}\right) \_ {p}_{1} ,$$

as well as an approval message signed by the fourth node,

$$E n d o r s e ( {b}_{1}^{'} , {b}_{1}^{"} , {b}_{1}^{" '} ) \_ {p}_{4} \text{.}$$

When at the end of an iteration a validator node has available the approval of at least N-F validator nodes on a composite block (including its own approval), the process stops and the composite block in question takes on the status of decided composite block.

Each decided composite block is associated with a quorum certificate. This quorum certificate consists of all of the approval messages that the validator node has available. All of the approval messages means those that it received from the other validator nodes as well as that which it generated during the same approval step of the same iteration.

Thus, in the example of FIG. 5B, the quorum certificate associated with the decided composite block

$${{b}^{′}}_{1} , {{b}^{″}}_{1} , {{b}^{‴}}_{1}$$

by the first validator node is given by

$$Q C = \left\{E n d o r s e \left({{b}^{′}}_{1} , {{b}^{″}}_{1} , {{b}^{‴}}_{1}\right) \_ {p}_{1} ,\right)$$

$$E n d o r s e \left({{b}^{′}}_{1} , {{b}^{″}}_{1} , {{b}^{‴}}_{1}\right) \_ {p}_{3} ,$$

$$\left(E n d o r s e \left({{b}^{′}}_{1} , {{b}^{″}}_{1} , {{b}^{‴}}_{1}\right) \_ {p}_{4}\right\} .$$

It should be noted that other validator nodes can provide validation certificates for the same composite block insofar as they do not necessarily receive the same approval messages.

According to one alternative, the approval message also comprises the number of the step and the index of the iteration during which it was generated. In this case the quorum certificate can take on the following form:

$$Q C = \left\{E n d o r s e \left({{b}^{′}}_{1} , {{b}^{″}}_{1} , {{b}^{‴}}_{1} ; i , r\right) \_ {p}_{1} ,\right)$$

$$E n d o r s e \left({{b}^{′}}_{1} , {{b}^{″}}_{1} , {{b}^{‴}}_{1} ; i , r\right) \_ {p}_{3} ,$$

$$\left(E n d o r s e \left({{b}^{′}}_{1} , {{b}^{″}}_{1} , {{b}^{‴}}_{1} ; i , r\right) \_ {p}_{4}\right\} .$$

where i is the index of the iteration and r is the number of the step of generation of the approval messages in question.

More generally, the quorum certificate associated with the instance of validation j is in the form:

$$Q {C}_{j} = \left\{E n d o r s e \left({b}_{j}^{\left({k}_{1}\right)} , ... , {b}_{j}^{\left({k}_{N - F}\right)} ; i , r\right) \_ {p}_{{k}_{1}}\right) ,$$

$$\left(... , E n d o r s e \left({b}_{j}^{\left({k}_{1}\right)} , ... , {b}_{j}^{\left({k}_{N - F}\right)} ; i , r\right) \_ {p}_{{k}_{N - F}}\right\}$$

where

$${b}_{j}^{\left({k}_{1}\right)} , ... , {b}_{j}^{\left({k}_{N - F}\right)}$$

denotes here the composite block approved by the N-F nodes k₁,...,k_{N}__{F} during the instance of validation j.

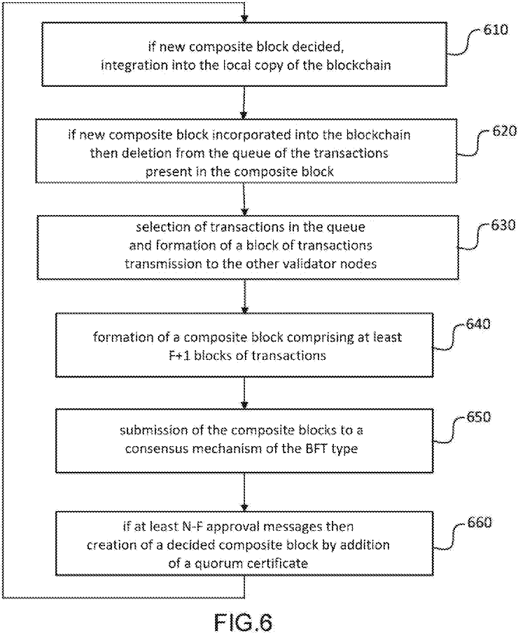

FIG. 6 shows in the form of a flowchart the steps carried out by a validator node in a method for forming a blockchain using the consensus mechanism of FIG. 4.

It is recalled that each validator node receives the transactions emitted by the clients and transmits them to the other validator nodes according to a service of the Best Effort type. It also has available its own local copy of the blockchain.

One validator node out of N will now be considered.

When this validator node observes in 610 that a new composite block having a rank j has been decided, in other words validated by consensus with at least ƒ validations in the associated quorum certificate QCⱼ, it adds this new composite block to its local copy of the blockchain.

As soon as a new composite block is incorporated into the blockchain, more precisely into its local copy, the validator node deletes from the queue all the transactions present in the composite block in question, 620.

The validator node then prepares in 630 a block by selecting the transactions available in the queue, starting with the oldest, in other words by popping the transactions of the FIFO buffer that stores them. In order to order the transactions, each transaction can be timestamped during its reception. It transmits the block thus formed, called proposed block, to all of the other validator nodes.

In 640, it forms a composite block comprising ƒ ≥ F+1 proposed blocks and generates a certified composite block, that is to say a composite block to which a pointer pointing to the preceding composite block, as well as the quorum certificate of the preceding composite block, are added.

In 650, the validator node submits the certified composite block that it generated in the previous step to a consensus mechanism of the BFT type. In this consensus mechanism, each validator node proposes for the approval of the other validator nodes the certified composite block that it generated.

In 660, if the validator node has available at least N-F (and thus at least 2F + 1) approval messages of validator nodes, it declares it as decided and adds to it the quorum certificate.

The process then continues by returning to step 610.

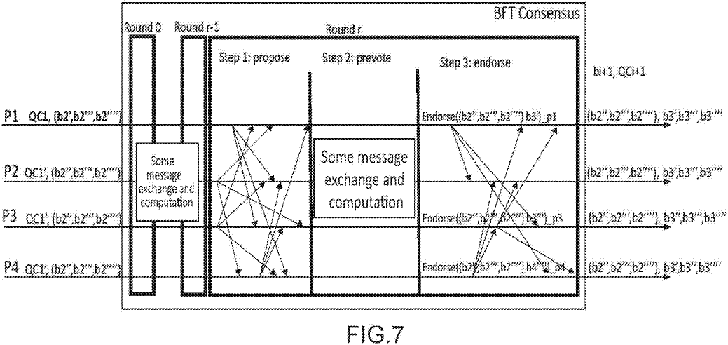

FIG. 7 schematically shows a consensus mechanism of the BFT type used in a method for forming a blockchain according to an embodiment of the present invention.

This embodiment differs from the previous one in that the phase of combination/certification and the phase of consensus are pipelined. In other words, each validator node proposes a block to form the following composite block at the same time as it carries out a validation of the current composite block. This feature allows to reduce the time separating the sending of a transaction by a client from its incorporation into the blockchain, and thus the latency of the formation of the blockchain.

More precisely, according to the present invention, each validator node transmits to the other validator nodes an extended approval message, approving on the one hand a current composite block like in FIG. 5B and proposing on the other hand a new block for the formation of the following composite block.

The extended approval message emitted by the validator node k can for example take on the following form:

$$E n d o r s e * \left\{\left({{b}^{′}}_{j} , {{b}^{″}}_{j} , {{b}^{‴}}_{j} ; i , r\right) , {b}_{j + 1}\right\} {P}_{k}$$

where

$${{b}^{′}}_{j} , {{b}^{″}}_{j} , {{b}^{‴}}_{j}$$

form the j^{th} composite block approved by the node k to be incorporated into the blockchain as a composite block having the rank j (that is to say the instance of validation j) and where bⱼ₊₁ is the block of transactions proposed by this same node to form the (j + 1)^{th} composite block and finally _pₖ means that the message is signed by this node.

An extended quorum certificate of a composite block can thus be formed:

$$Q {C}_{j}^{*} = \left\{E n d o r s e * \left\{\left({b}_{j}^{\left({k}_{1}\right)} , … , {b}_{j}^{\left({k}_{N - F}\right)} ; i , r\right) {b}_{j + 1}^{\left({k}_{1}\right)}\right\} \_ {p}_{{k}_{1}} , … , E n d o r s e * \left\{\left({b}_{j}^{\left({k}_{1}\right)} , … , {b}_{j}^{\left({k}_{N - F}\right)} ; i , r\right) {b}_{j + 1}^{\left({k}_{N - F}\right)}\right\} \_ {p}_{{k}_{N - F}}\right\}$$

where it has been supposed that the nodes k₁,...,^{k}N_{-F} approved the composite block

$${b}_{j}^{\left({k}_{1}\right)} , … , {b}_{j}^{\left({k}_{N - F}\right)} \left({{b}^{′}}_{j} , {{b}^{″}}_{j} , {{b}^{‴}}_{j}\right)$$

in the example illustrated in FIG. 7) during the instance of validation j and that the blocks of transactions proposed by these same nodes for the formation of the following composite block are respectively

$${b}_{j + 1}^{\left({k}_{1}\right)} , … , {b}_{j + 1}^{\left({k}_{N - F}\right)} ⋅$$

According to a specific alternative embodiment, the blocks of transactions

$${b}_{j + 1}^{\left({k}_{1}\right)} , … , {b}_{j + 1}^{\left({k}_{N - F}\right)}$$

can include only a single transaction each, in other words

$${b}_{j + 1}^{\left({k}_{1}\right)} , … , {b}_{j + 1}^{\left({k}_{N - F}\right)} = {t}_{j + 1}^{\left({k}_{1}\right)} , … , {t}_{j + 1}^{\left({k}_{N - F}\right)} .$$

It is noted in the expression (4) that the extended quorum certificate of the composite block

$${b}_{j}^{\left({k}_{1}\right)} , … , {b}_{j}^{\left({k}_{N - F}\right)}$$

gives the proposition of the following composite block

$${b}_{j + 1}^{\left({k}_{1}\right)} , … , {b}_{j + 1}^{\left({k}_{N - F}\right)} .$$

In other words, any proposition of a composite block is thus accompanied by a construction of the quorum certificate of the preceding composite block. It is therefore implicitly certified, which allows to do without a distinct previous certification phase. This new certified composite block is thus submitted to a new instance of validation j+1.

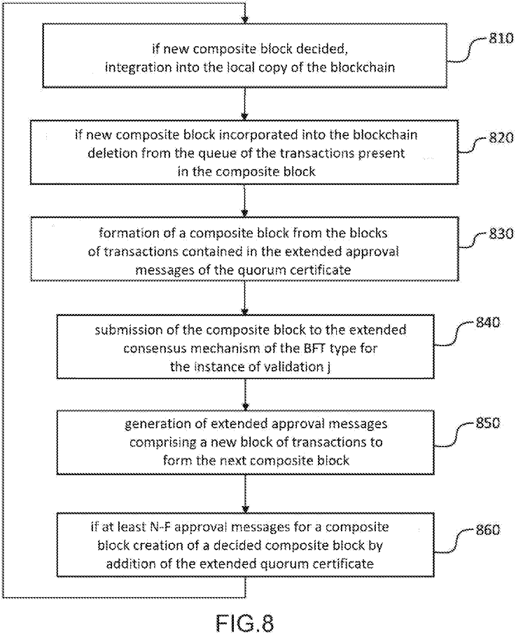

FIG. 8 shows in the form of a flowchart the steps carried out by a validator node in a method for forming a blockchain using the consensus mechanism of FIG. 7.

Like in the first embodiment, each validator node receives the transactions emitted by the clients and transmits them to the other validator nodes according to a service of the Best Effort type.

One validator node out of N will now be considered.

When this validator node observes in 810 a new decided composite block having the rank j, in other words validated by an extended quorum certificate

$$Q {C}_{j}^{∗} ,$$

it adds this new composite block to its local copy of the blockchain. The composite block stored in the blockchain is certified, that is to say that it is stored with the extended quorum certificate of the preceding composite block,

$$Q {C}_{j - 1}^{*} ,$$

as well as with a pointer to the latter.

As soon as a new composite block having the rank j is incorporated into the blockchain, more precisely into its local copy, the validator node deletes from the queue all the transactions present in the composite block in question, 820.

In 830, the validator node forms a new composite block from at least ƒ extended approval messages that it has available, contained by construction in the last extended quorum certificate,

$$Q {C}_{j}^{*} .$$

In 840, the validator node submits the certified composite block to the extended process of consensus of the BFT type, for the instance of validation j .

In 850, in this consensus process, the validator node determines whether the composite blocks that it receives from the other nodes are valid and if yes returns to them an extended approval message, said extended approval message containing a new transaction block to form the next composite block.

In step 860, if the validator node observes at least N-F extended approval messages for a composite block, it creates a decided composite block by addition of the extended quorum certificate. The extended quorum certificate comprises all of the extended messages received by the validator node, approving the composite block in question.

The process then continues by returning to step 810.

1. A method for forming a blockchain involving a plurality N of validator nodes, comprising at most F faulty nodes with N > 3F , each validator node having available a local copy of the blockchain and receiving the transactions emitted by clients, each validator node further storing these transactions according to their order of arrival in a queue and creating a block of transactions by popping the queue starting from the oldest transaction, wherein each validator node:
during a consensus phase of the BFT type, determines whether composite blocks, formed by a number ƒ of blocks with ƒ ≥F+1, proposed by the other validator nodes during the current instance of validation are valid and, if yes, sends back to these nodes an extended approval message, said extended approval message comprising the composite block validated during the current instance of validation as well as a new block of transactions intended to form a new composite block during the following instance of validation;
when it has available at least N - F messages of approval of the same composite block, creates a decided block comprising said composite block and an extended quorum certificate, the extended quorum certificate being composed of said at least N - F extended approval messages relative to said composite block;
when it has available a decided block, adds the composite block in question to the local copy of the blockchain;
forms said new composite block from the new blocks of transactions contained in the ƒ extended approval messages of the extended quorum certificate.

2. The method for forming a blockchain according to claim 1, wherein each validator node transmits the transactions received from the clients to the other validator nodes according to a service of the Best Effort type.

3. The method for forming a blockchain according to claim 1, wherein the number of validator nodes comprises exactly F faulty ones and ƒ ≤N-F.

4. The method for forming a blockchain according to claim 1, wherein after having formed the new composite block, the validator node adds to it the quorum certificate of the preceding composite block as well as a pointer to the preceding composite block.

5. The method for forming a blockchain according to claim 1, wherein when a composite block is incorporated into the blockchain, the validator node advantageously deletes from its queue all the transactions present in said composite block.

6. The method for forming a blockchain according to claim 1, wherein the consensus phase comprises a plurality of successive iterations, each iteration comprising a proposition step in which each validator node proposes a block of transactions, a step of consultation among the validator nodes, and an approval step in which each validator node indicates to the others the composite block that it validated via an extended approval message that it transmits to them.

7. The method for forming a blockchain according to claim 5, wherein an extended approval message emitted by a validator node comprises the composite block validated by this said node, the index of the iteration and the step of the iteration during which it validated it, the new block of transactions intended to form a new composite block during the following instance of validation, said approval message being signed by a private key of the validator node.
